(19) United States
(12) Patent Application Publication
(10) Pub. No.: US 2011/0140844 A1
(43) Pub. Date: Jun. 16, 2011

(54) PACKAGED PRODUCT HAVING A REACTIVE LABEL AND A METHOD OF ITS USE

(76) Inventors: Kenneth Stephen McGuire, Cincinnati, OH (US); Dean Larry DuVal, Lebanon, OH (US)

(21) Appl. No.: 12/638,024

(22) Filed: Dec. 15, 2009

(51) Int. Cl. G08B 5/22

(52) U.S. Cl. 340/6.1

(57) ABSTRACT

A reactive label is capable of reacting with a shopper that peruses the label while considering the purchase of the labeled product. The label includes sensors and a display unit and is powered by incorporated batteries or photovoltaic cells. The sensors can include a timer that provides the shopper with additional information from a ROM by displaying it sequentially on an LCD screen or the like. The sensors can also include a sensor such as an optical sensor that measures such factors as hair reflectance and can inform the shopper as to the suitability of the product (if, for example, it is a shampoo) for their personal use. The reactive label gives the shopper a previously unattainable sense of product personalization and will thereby enhance a sense of loyalty to and confidence in the product.

### FIELD OF THE INVENTION

This invention relates generally to product packaging and labeling, particularly to the use of electronically enabled labels that react to the presence of a potential purchaser and provide information specific to that person.

### BACKGROUND OF THE INVENTION

The use of labels to describe the contents and utility of a packaged product is as old as the use of containers that hold and display such products. Modern packaging techniques often present a product in an opaque and sealed packaging medium. This can be a negative factor in the marketing of personal care and cosmetic products, where such sense data as the color and aroma of the product can be important factors to the shopper as can the shopper's knowledge of the properties of the various oils, emollients and preservatives that are in the product and subsequently applied to the skin. The shopper of today is quite aware of factors influencing product suitability and seeks as much information as possible about the nature of the product before purchasing it.

The typical product label provides only a fixed and unchanging description of the packaged product. We shall call such a label a “static” label. The purpose of the static label is twofold. First, it is an advertisement, whose appearance is meant to attract the eye of a potential consumer. Typically, to fulfill this function, the static label displays pictorial content that is recognizable as designating a particular brand in which the shopper may or may not have confidence and to which the shopper may or may not be loyal.

Second, the static label conveys information about the contents of the packaged product being considered by the shopper for purchase. This information can be in the form of a written description or it can also be pictorial in nature.

Some labeling schemes are capable of imparting simulated motion to an illustration on the label in order to enhance its advertising function. For example, there are labels that can display a sequence of edge-lit images to give the impression of an object in motion, such as a bird flapping its wings. Such an invention is disclosed by Harry, Brent D. in US Published Application 2006/0207134. There are labels that are overlaid with transparent lenticular optical films that can display several different independent images positioned beneath the film depending upon the angle of the viewer's line of sight relative to the plane of the film. Such multi-focal plane illustrations can also create the illusion of motion as the viewer either moves their eyes or moves the label itself. Indeed, as is described by Thomas et al. in U.S. Pat. No. 6,798,409, such optically sophisticated labels can even project a 3-dimensional image beyond the immediate environs of the product. We will denote such labels as “dynamic labels,” because they can create movement, animation or sensations such as greater spatial extent. Nevertheless, the information content of such labels is fixed, even though they may create illusions of motion or enhanced dimensionality. Moreover, none of these dynamic labels truly reacts to the shopper because the transmission of information between the product and the shopper is designed to be one-way. The product, in effect, tells the shopper what it is, but the shopper cannot tell the product who they are. We shall now denote labels that can actually react to the shopper as “reactive labels,” which indicates their additional properties beyond mere dynamism. It is to the creation of such reactive labels that the present invention is directed.

### SUMMARY OF THE INVENTION

A first object of this invention is to provide a reactive label and a packaged product incorporating that label that is aware of the presence of a shopper and can alter the information it provides in accord with that knowledge.

A second object of this invention is to provide such a reactive label and packaged product whose information content is not static but is functionally dependent upon certain characteristics of the shopper and their relationship to the properties of the product.

A third object of the present invention is to provide such a reactive label and packaged product that incorporates a logic-driven feedback property by which information transferred between the label and the shopper can change during the time that the shopper is interacting with the labeled product.

A fourth object of the present invention is to provide such a reactive label and packaged product that reinforces a sense of product loyalty within the shopper by means of a personalization of the product contents to the characteristics of the shopper.

A fifth object of the present invention is to provide a mechanism by which a shopper can obtain optimal benefits from a product or a suite of products by means of determining a satisfactory match between the properties of the product and the personal characteristics of the shopper.

These objects will be achieved by means of a logic-driven electronically enabled label that may include such elements as a power supply, a microprocessor, miniature sensors, a random access memory unit (RAM), a read-only memory unit (ROM) that contains display information and may contain operational logic, and electro-optical circuitry for creating a visible, dynamic display. The label can be powered by small flexible batteries, small photovoltaic cells or any of a wide variety of small, flexible power sources such as devices that extract energy from a RF transmitter (such as an in-store transmitter) or that extract (“harvest”) energy from ambient electromagnetic fields. If photovoltaic cells are used as a power source, the cells can be designed for broadband spectral sensitivity or selective sensitivity to in-store ambient lighting or external sunlight. The flexible integrated circuit package can be assembled using self-assembly technologies such as the web process interconnect methodology described by Jacobsen et al. in U.S. Pat. No. 6,468,638, assigned to Alien Technologies which is fully incorporated herein by reference. Such all-encompassing assembly methodologies can be used to produce, in a low cost reel-to-reel process, a “smart flexible backplane” embedded with sensors, semiconductor logic and random access memory (RAM). The RAM can contain both specific information to be presented to the shopper and the logic that, in combination with sensor input, determines what information is to be given. When combined, for example, with a flexible printable color display technology as disclosed by Doane et al. in U.S. Pat. No. 7,236,151 and printable solar cell technology structured as taught in US Published Patent Application 2004/0017524, both of which are fully incorporated herein by reference, the result can be an ambient light powered label that can sense different intensities of ambient light, sense the presence of a shopper nearby, sense when it is picked up and/or its environment and change its display accordingly.

### BRIEF DESCRIPTION OF THE DRAWINGS

FIG. 1 is a schematic representation of an exemplary dynamic label of the present invention, showing its external appearance.

FIG. 2 is a schematic representation of a block diagram implementing the label of FIG. 1, showing the components and their interconnections.

### DESCRIPTION OF THE INVENTION

The embodiments of the present invention are reactive labels that provide a logic and sensor-driven flow of information between a shopper and the product so labeled. The individual label incorporates sensor-enabled miniaturized flexible electronic circuitry that allows a shopper to interact with the packaged product and obtain various degrees of personalized information about its properties and optimal use.

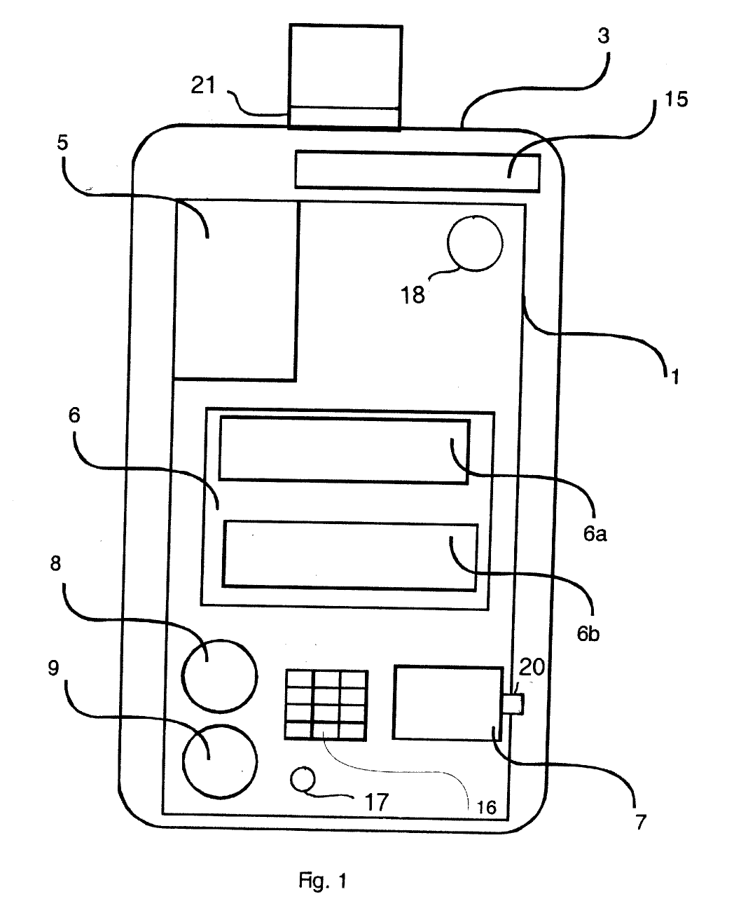

Referring first to FIG. 1 there is shown a schematic illustration of an embodiment of the present invention. The electronically-enabled reactive label 1 is shown as being affixed to an exemplary bottle 3, which may either be inside a box or, as is shown here, displayed in the store in an un-boxed configuration.

On cursory inspection, the reactive label appears externally similar to ordinary static labels. It includes static display unit 5 that is visible under all conditions and requires no power. In the present example, the static portion could simply state “Shampoo” or the like, to indicate the bottle contents. The reactive label 1 will include a dynamic portion 6 that encompasses both a portion suitable for presenting a pictorial representation 6a and a separate portion, or the same portion, for displaying lines of text 6b. These potentially power consuming regions are activated by particular actions of a shopper, such as lifting up the bottle for closer examination or utilizing sensors contained in the label as will shortly be discussed. The display units 6a, 6b can be small LCD screens or a succession of edge lit panels as provided by Harry in US Published Application 2006/0207134 cited above. The choice of display technology will depend on power consumption considerations as well as on the nature of the material to be displayed, e.g. colored pictorial displays, black and white pictorial displays, text displays in black and white or in color, numerical displays, or the like.

Unlike a completely static label, however, the reactive label also includes a small power supply or energy source 7, which could be a strip of flexible photovoltaic (PV) cells, but which could also be a small, (possibly flexible) battery that would be protectively encased beneath the label surface (replaceable or rechargeable) or any of a variety of other power sources mentioned above. Since the functionality of the label does not require high power, a small strip of PV cells, typically about 1.5 volts, should be sufficient. Kurtz et al. (US Published Patent Application 2008/0048102), which is fully incorporated herein by reference, discloses a wide variety of flexible and printable power supplies that would be appropriate for this embodiment.

In an embodiment of the label incorporating one or more batteries, the label may comprise an activation element 20 including a switch element and/or a means for activating the circuitry by altering the state of the switch and completing the circuit. Such a means may comprise a pull-tab, removable cover, or other type of switch as these options are known in the art. In this embodiment, utilizing the activation element at the time of placing the package in the shopping environment may activate the circuitry at that time while allowing the batteries to be preserved prior to that time. In this embodiment, the label may exist in a stand-by state until the activation element is utilized to alter the state from stand-by to active. The label in the stand-by state utilizes little or no energy and thereby conserves the limited resources represented by the one or more on-board batteries.

Further distinguishing the appearance of the reactive label 1 from a static label is the presence of one or more sensors 8, 9, two being shown for exemplary purposes. These miniaturized, low power (or unpowered) sensors would be matched to the characteristics of the shopper, the desired performance of the label/product combination, and the properties of the product.

A sensor of the label may provide information relating to an object of an intended use of the packaged product. As a non-limiting example, if the product is a shampoo, one sensor 8 could be a simple photocell that was made sensitive to the reflectivity of hair. A spectral band-pass filter could be placed over the cell to make it react to certain hair colors. Shampoos are typically located on display shelves according to hair type, so equipping the label with a proper filter is easily done. A second sensor 9 could be a simple timer that registers the amount of time the shopper is holding the package. The timer could itself be activated by an additional sensor that reacts to touch, positional change, or the like. The length of time that a shopper examines a package is a good indication of their interest in its purchase and also an indication that the shopper is reading the label carefully to determine information about the product. The timer can signal the logic unit that the shopper may require more information, at which point the display may be changed to show additional information from the RAM not initially visible. The additional information displayed may be associated with the output of the one sensor 8.

With the reactive label of the present invention, the interested shopper may be presented with additional relevant information on a “desire to know” basis, depending upon the length of time the package is being held and information detected by sensors.

The label could also incorporate a small flexible keyboard 16 on which information could be entered by the user. The label may also comprise one or more radio type buttons 17 enabling the shopper or ultimate consumer of the product to input information to the label. The bottle could also include a magnetic stripe or the like, 15 that can be used to provide or receive data at a point of purchase The magnetic stripe need not be a permanent portion of the label, it may be removable at the point of purchase or it may be deactivated. The presence of the magnetic stripe also enables the label to be used as a store of additional information or to download information about the shopper to a manufacturer's website or to a website maintained by the purveyor of the product.

The label may also comprise a memory element 19 which may be read or written to using radio frequency electromagnetic energy. Such an element provides an additional means of storing information about the product or the shopper within the label.

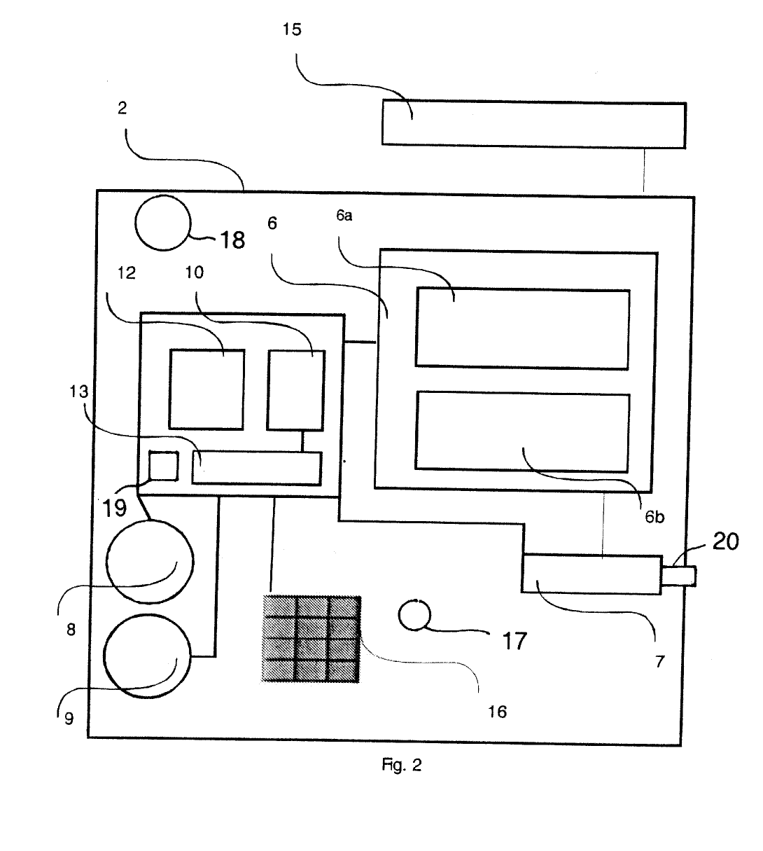

Referring now to FIG. 2, there is shown a schematic and simplified block diagram of an integrated circuit, preferably fabricated on a flexible substrate 2, that would satisfy the objects of the present invention. This circuit is the electronic portion of the reactive label of FIG. 1 and, according to an aspect of the invention, it is encapsulated within the label to form an integral part of the label. It is noted that the layout of the circuit elements on the substrate is not critical but will conform to space requirements of the label and, further, that all individual circuit components are known in the prior art as cited herein. It is also noted that flexible substrates can incorporate discrete units, such as logic units and keyboards and can also have circuitry and connective wiring imprinted on them using several methodologies, ranging from the assembly processes disclosed in Doane, et al. U.S. Pat. No. 7,236,151 cited above, to those of Islam et al. (US Publ. Pat. Appl. 2004/0018422).

The present circuit comprises a microprocessor unit 13, whose role, among others, is to provide a correctly time sequenced series of operations initiated by input from any of the sensors (two being shown here 8 and 9) and to control the flow of logical actions. The microprocessing unit has access to a repository of logical operations, preferably stored in a ROM 10 or other source of fixed logic such as a PLA (programmable logic array) (not shown). The ROM 10 also stores information that can be presented visually as text or pictorial data on an appropriate display unit 6 as previously mentioned. A power supply or energy source 7 can be either photovoltaic cells or chemical batteries, both of which are well known in the art (see Kurtz, et al., above). The choice of power supply will depend strongly on the power consumption of the display unit, which, in turn, can depend on the overall dimensions of the label and the type of information it is intended to display.

The label may further comprise a microphone 18 an/or a output speaker or speaker driver. In one embodiment the speaker driver may be coupled to the primary or secondary package of the product offering. In this embodiment, the speaker driver may use the package as a driven member. This particular embodiment may be used to provide an audible cue relating to the quantity of the product present in the package. As the effective air column present in the package and subject to the output of the driver increases with product dispensing. The output tone produced will be altered in accordance with the change in the air column. In this embodiment it may be possible for the consumer of the product to activate the speaker to output a particular frequency which will not vary over the useful life of the package. The audible tone produced by the combination of the partially filled package and the frequency will vary as the contents of the package are consumed. This will enable the consumer of the product to “ping” the package to ascertain the amount of product remaining for consumption. The speaker may also be used to provide information in an audible form to the shopper or consumer.

In one embodiment the microphone of the label may serve as an input device enabling the shopper or consumer to provide information to the label via speaking into the microphone.

In its quiescent phase, when the package is residing on a display shelf and no shopper activation has yet occurred, the label could appear as a typical static label. Typically, if it is desired to conserve energy, no information is presented on the display portion of the label (6 in FIG. 1). In fact, the label is shown to include a separate static label portion 5, precisely for the purpose of “stand-by” visibility while it is drawing no power. Alternatively, this “stand-by” portion of the reactive label can be a dynamic label, such as either of the dynamic portions 6a or 6b of FIG. 1, generating an animated pictorial effect or the like, to be attractive to shoppers, but drawing very little power.

Below, there is shown a possible sequence of eight operations (“Steps”) performed by the reactive label upon initiation of label operation. The process is initiated by a dynamic display that attracts the attention of a shopper, and continues when the prospective shopper picks up the labeled package for perusal. These steps are written out below in detail. It is understood that the actual sequence of operations will depend on the type of product and the nature of the sensors incorporated within the label. In this embodiment the exemplary product will be assumed to be a shampoo for “dark hair”. There are two sensors incorporated within the label, one sensor 8 being a timer that reacts to the lifting of the package (or otherwise handling the package) and initiates a set of operations thereafter, the other sensor 9 being an optical sensor that reacts to ambient light reflections from the shopper's hair (for this shampoo example).

Step 1: A dynamic display is used to attract the attention of a shopper.

Step 2: Shopper lifts package for inspection purposes, timer (or other sensor indicating the package is being handled) turns on power and elapsed time begins being measured. The elapsed time is communicated to the processing unit.

Step 3: Sufficient time has elapsed to trigger first reaction by processor unit. An additional text message or other form of information stored in ROM is displayed, which (for example) asks shopper to hold the optical sensor near their hair.

Step 4: Sensor notes reflected light intensity, logic device compares reflected light with ambient light in store and computes a reflectance factor for the shopper's hair.

Step 5: If sensor cannot evaluate shopper's physical characteristic, a message will appear asking for the shopper to answer a series of questions using the keypad.

Step 6: Based on the computed reflectance factor, or the keypad data entry, the processing unit triggers the display of additional information, stored in ROM, which additional information can indicate the suitability or unsuitability of this particular product for the shopper.

Step 7: The shopper reacts by placing the product in their shopping cart, whereupon the timer sends a termination signal to the processor and the power is turned off.

Step 8: At the checkout counter, the shopper's information, if required, can be uploaded through the magnetic stripe or further information can be downloaded to the magnetic stripe or other accessible memory incorporated into the label.

In one embodiment the label/package combination may comprise sufficient memory to enable the storage and display of all provided information in any one of a plurality of languages with a shopper able to select from amongst the plurality using radio buttons on an interactive display, a keyboard selection or via a microphone using speech recognition software to determine which language to display.

The shopper may provide inputs to the label to sequentially display a series of items stored in the memory. The input may be via a button, the keyboard, the microphone or other sensors. The logic of the label may then utilize the provided input to determine what information should be displayed. In this manner additional information about the product or related products may be provided to the shopper or consumer.

In one embodiment the technology of the label may assist the shopper in selecting the appropriate product. The sensor of the label may be used to determine an attribute of the shopper or the environment related to the intended sue of the product. In this manner the shopper may utilize the label to determine if the shampoo is correct for their hair type and hair condition. Similarly, the shopper may evaluate their skin condition or color with regard to skin care products or determine the current state of an intended object of the product prior to selecting the product.

In one embodiment a portion of the reactive label, up to and including the entire reactive label, may be releasably attached to the package as is known in the art. In this embodiment, the shopper or subsequent user of the packaged product may remove the reactive label. The removed label may be used as a diagnostic device to evaluate an object of an intended or potential use of the packaged product, or of a complimentary or related product. The reactive label may comprise a sensor for the purpose of evaluating the object and the display may be altered to provide information relating to a product selected according to the sensor input.

In one embodiment the label sensor may provide an indication of water condition and this indication may be used as a basis for providing dosing information to the product user via the display. As an example, the sensor may provide an indication of the level of water treatment chemicals such as chlorine or bromine which are present in the water of a swimming pool. This indicated level may be used alone or in conjunction with other input from a user to indicate via the display the proper dosing of a water treatment chemical.

The reactive labels may be used in conjunction with products in packaging which allows for alterations to the dispensed product based upon environmental factors and/or user input. The package in such embodiments comprises an adjustment element 21 adapted to alter the ratio of product components in the dispensed product or the amount of product dispensed as a unit dose. The adjustment element may function by altering the orifice through which a particular component is dispensed prior to combining with other product components and thereby altering the relative proportions of the respective product components. The adjustment element may be calibrated and may be functionally linked to a user accessible control device such as a slider switch or a rotatable wheel to enable the user to change the ratio of components. The display may be used to provide an indication to the user of a desired setting for the adjustment element based upon the input from the sensor and/or the user via the keyboard or radio buttons as such input is processed by the control logic.

In one embodiment the sensor may indicate the extent of ultra-violet light exposure at a location. This information may be used to provide a product user with a package setting to apply to a sunscreen package to adjust the mix ratio of product ingredients to raise or lower the effective Sun Protection Factor (SPF) of the product as dispensed. In this embodiment, coextensive exposure of the sensor and the user to the same UV source could be used to provide an indication of when the product should be reapplied or when exposure under the current application should cease.

In one embodiment the sensor could provide an indication of the degree of halitosis of a user of a dentifrice product by sensing the presence and concentration of sulfurous compounds in the breath of the user. This information could be used to determine and display a ratio setting to be applied to the dentifrice product package to alter the relative proportions of the respective components of a compound product which is mixed as it is dispensed. The alteration of the ratio could yield a mixture more suited to the elimination of the sulfurous compounds during the use of the product.

In one embodiment the product may comprise a multi-component air freshener system which varies the provided scent over time by altering the ratio of the available scents dispensed. In this embodiment, the label may allow the user of the product to alter the range of scents provided including limiting the provided scent to a single favorable or desired scent. In this embodiment, the user may provide input via the reactive label to constrain the dispensed ratios of components as desired.

The reactive label may alter the display to serve as a coupon for the labeled product or a different product, or may simply provide information relating to the selected product.

The display of the label may be modified to present information relating to the use of the product under specific circumstances according to input provided by either the label sensors or by the shopper or consumer of the product. The display may be modified to either show or hide icons, words or images. The display may be modified to provide information on related products or product variants according to provided inputs. The display may be modified to function as a coupon by displaying an offer related to the packaged product or to a different product, either a related or unrelated product. A related product may include a product associated with the use of the initial product or that may be used in conjunction with the initial product. Paper towels may be associated with surface cleaning products, skin care products may be associated with shaving implements, shampoos and conditioners may be associated with each other. Unrelated products have no such close association. As an example pet food offers may accompany a diaper purchase. The display may modified to provide information relating to shopper loyalty programs associated with either the manufacturer of the product or the retail outlet at which the product is being considered for purchase.

In one embodiment a label writer may be incorporated into the check-out system of a retailer to write to the label to provide retailer specific information or information derived according to the current items being purchased, or according to information associated with the particular shopper via information stored in a shopper loyalty database or the retailer.

The display may be modified to provide information regarding additional sources of information such as internes website addresses, other media sources, and other contact information relating to the product or manufacturer of the product.

In one embodiment the display may be modified to show a barcode or other coded image which may in turn be scanned and interpreted using a digital image scanner such as a digital camera. The scanned image may be interpreted to serve as an input in a communications protocol to afford the user access to additional information relating to the product.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A packaged product comprising a reactive label, the label comprising a display, control logic and an input sensor, the label adapted to alter the display according to the interaction of the sensor and the logic.

2. The packaged product according to claim 1 wherein the alteration of the display includes altering the language of at least a portion of information displayed.

3. The packaged product according to claim 1 wherein the alteration of the display includes an item selected from: hiding a portion of the display such as icons, words, or pictures; modifying instructions for substrates product can be used on; modifying instructions for how to use product on substrates; identifying other product variants within the category that may be more appropriate for purchase; identifying products outside the category for purchase; offering discounts for purchase of other products; showing information on shopper loyalty programs; or identifying sources of additional product information such as websites, literature, or visual media outlets; and combinations thereof.

4. The packaged product according to claim 1 wherein a shopper provides input via the sensor.

5. The packaged product according to claim 1 wherein the sensor provides information relating to an object of an intended use of the packaged product and the display is altered according to the provided information.

6. The packaged product according to claim 1, the package further comprising a keyboard and/or radio input buttons.

7. The packaged product according to claim 1, the package further comprising a speaker driver.

8. The packaged product according to claim 1 the package further comprising a microphone.

9. The packaged product according to claim 1 wherein at least a portion of the reactive label is releasably attached to the package.

10. The packaged product according to claim 9 wherein the portion of the reactive label that is releasably attached to the package is a smart coupon.

11. The packaged product according to claim 9 wherein the portion of the reactive label that is releasably attached to the package is a diagnostic device.

12. The packaged product according to claim 1 wherein the reactive label comprises a writable memory element.

13. The packaged product according to claim 1 wherein the reactive label comprises a plurality of sensors.

14. The packaged product according to claim 1 wherein the reactive label comprises a standby state.

15. The packaged product according to claim 1 wherein the reactive label comprises an activation device including but not limited to pull-tabs, switches, or removable covers.

16. The packaged product according to claim 1 wherein the package comprises a calibrated adjustment element adapted to alter the ratio of components in a dispensed product and the display may be modified to indicate a setting according to the input of the sensor.

17. The packaged product according to claim 1 wherein the package comprises an calibrated adjustment element adapted to alter the amount of a dispensed product and the display may be modified to indicate a setting according to the input of the sensor.
